(19) United States
(12) Patent Application Publication
(10) Pub. No.: US 2009/0037387 A1
(43) Pub. Date: Feb. 5, 2009

(54) METHOD FOR PROVIDING CONTENTS AND SYSTEM THEREFOR

(75) Inventor: Soo-Woong KIM, Seoul (KR)

Correspondence Address: Jefferson IP Law, LLP, 1730 M Street, NW, Suite 807, Washington, DC, 20036, US

(73) Assignee: Alticast Corp., Seoul (KR)

(21) Appl. No.: 12/185,498

(22) Filed: Aug. 4, 2008

(30) Foreign Application Priority Data
Aug. 2, 2007 (KR) 2007-0077896
Aug. 20, 2007 (KR) 2007-0083684

(51) Int. Cl. G06F 17/30

(52) U.S. Cl. 707/3; 707/E17.074

(57) ABSTRACT

Disclosed is a method for providing contents using a keyword, and a system therefor. The content provision method includes the steps of generating keywords for broadcast programs, extracting contents by using the keywords, and providing a user interface (UI) to provide the contents by displaying the keywords on a display unit. Accordingly, the inconvenience and troublesomeness of character input are eliminated, and it is possible to satisfy the users' desires for acquisition of knowledge and information by actively providing various information to the users.

### PRIORITY

This application claims priority to application entitled “Method For Providing Contents And System Therefor” filed with the Korean Intellectual Property Office on Aug. 2, 2007 and assigned Serial No. 2007-77896, and filed Aug. 20, 2007 and assigned Serial No. 2007-83684, the contents of which are incorporated herein by reference.

### BACKGROUND OF THE INVENTION

1. Field of the Invention

The present invention relates to a method for providing contents and a system therefor, and more particularly to a method for providing contents using a keyword, and a system therefor.

2. Description of the Related Art

In the case of electronic devices, such as a television, to which the user's instructions are inputted through buttons on a remote controller, a user's instruction for character input must be input through the operation of character input buttons, wherein such an input operation may be troublesome to the user. In addition, presently, such an electronic device shows a tendency to be a multi-functional, and provides more and more functions, so that a user's desire to input characters to the electronic device causes an increase in the number of buttons provided on a remote controller because one button is assigned one function in a general electronic device.

Especially, in the case of electronic devices, such as an Internet protocol television (IPTV), which can provide two-way communication, the transmission necessity and transmission opportunity to transmit characters in various manners in order to obtain various information about programs are increasing. In this case, if users can input characters only through the operation of the character input buttons of a remote controller, it may cause considerable inconvenience to the users.

Also, if a user must access the Internet in order to receive Internet contents desired by the user whenever the Internet contents are generated while the user is watching television, it may be very troublesome to passive users.

Therefore, it is necessary to develop a method capable of more easily and efficiently receiving contents, even without an operation of character input buttons, by electronic devices, such as an IPTV, which can provide two-way communication.

### SUMMARY OF THE INVENTION

Accordingly, the present invention has been made to solve the above-mentioned problems occurring in the prior art, and the present invention provides a method for providing contents and a system therefor, which can eliminate the inconvenience and troublesomeness of character input by providing contents using keywords provided by an audio/video (AV) device, instead of using an operation of the buttons of the AV device, and can satisfy the users' desires for acquisition of knowledge and information by actively providing various information to the users.

In accordance with an aspect of the present invention, there is provided a method for providing contents, the method including the steps of: generating keywords for broadcast programs by using broadcast program information; extracting at least one content relating to each keyword by using the keywords; and providing a user interface (UI) to provide the at least one extracted content by displaying the keywords on a display unit.

Preferably, the extracted content corresponds to broadcast related internet contents, which includes at least one among news, a moving picture, music, shopping information, an advertisement, traffic, personality information, a blog, a fan forum, and an original sound track (OST), and so on.

Also, preferably, the extracted content includes a content provided by a broadcast-related server, and the broadcast-related server includes at least one of a broadcasting station's server and a newspaper company's server, a show business company's server, an actor's homepage server and a film company's homepage server, and so on.

Also, in the keyword generation step, the keywords may be generated by using at least one among a title, a story line, players, background music, a location, and a genre of a program, which are provided through the broadcast program information.

Also, in the UI provision step, the keywords for a program currently being broadcasted may be displayed on the display unit.

Also, in the UI provision step, when one among the keywords displayed on the display unit is selected, at least one content relating to the selected keyword may be displayed on the display unit.

Preferably, in the UI provision step, when there are two or more contents relating to the selected keyword, a list of contents may be displayed on the display unit so that one of the contents is selected.

Preferably, in the UI provision step, the content is processed in a form suitable for broadcasting, and is then provided.

Also, in the UI provision step, the content may be processed to include tag information before the content is provided.

Here, the tag information may include at least one among personal video recorder (PVR) information, Video-on-Demand (VoD) information, and electronic program guide (EPG) reservation information.

Also, the method may further include a step of re-generating a keyword based on information about the extracted content, and adding the re-generated keyword to the keywords generated by using the broadcast program information.

Also, the method may further include a step of adding a keyword generated by a user's input to the keywords for the broadcast program, which are generated by using the broadcast program information, wherein, in the content extraction step, the keywords generated by using the broadcast program information and the keyword generated by the user's input may be used to extract the content.

Also, the method may further include a step of re-extracting a content based on at least one keyword included in the provided content, and providing a link for the keyword in order to provide the re-extracted content to a user.

Also, the method may further include a step of extracting an advertisement associated with the generated keyword or extracted content, wherein, in the UI provision step, when the keyword is displayed, or when the content is provided, the associated advertisement may be provided together with the keyword or the content.

Meanwhile, in accordance with another aspect of the present invention, there is provided a system for providing contents, the system including: an electronic program guide (EPG) server to provide broadcast program information; a keyword server to generate keywords for a broadcast program by using the provided broadcast program information; and a content server to extract at least one content relating to each keywords by using the keywords.

Preferably, the content server extracts broadcast related internet contents, which includes at least one among news, a moving picture, music, shopping information, an advertisement, traffic, personality information, a blog, a fan forum, and an original sound track (OST), and so on.

Also, the content server may extract a content provided by a broadcast-related server, and the broadcast-related server may include at least one of a broadcasting station's server and a newspaper company's server, a show business company's server, an actor's homepage server and a film company's homepage server, and so on.

Preferably, the keyword server generates the keywords by using at least one among a title, a story line, players, background music, a location, and a genre of a program, which are provided by the EPG server.

Also, the keyword server may provide a user with the keywords for a program currently being broadcasted.

Also, the keyword server may provide a user with the keywords, and when one among the keywords is selected, the keyword server may provide the user with at least one content relating to the selected keyword.

Also, when there are two or more contents relating to the selected keyword, the content server may generate a list of contents.

Also, the content server may process the content in a form suitable for broadcasting, and provide the processed content to the keyword server.

Also, the content server may process the content to include tag information, and provide the processed content to the keyword server.

Here, the tag information may include at least one among personal video recorder (PVR) information, Video-on-Demand (VoD) information, and electronic program guide (EPG) reservation information.

Also, the keyword server may re-generate keywords based on information about the content extracted by the content server, and add the re-generated keyword to the keywords generated by using the broadcast program information.

Also, the keyword server may add keywords generated by a user's input to the keywords for the broadcast program, which are generated by using the broadcast program information, and the content server may extract a content by means of the keywords generated by using the broadcast program information and the keyword generated by the user's input.

Also, the keyword server may add keywords generated by operator's input to the keywords for the broadcast program, which are generated by using the broadcast program information, and the content server may extract a content by means of the keywords generated by using the broadcast program information and the keyword generated by the operator's input.

Also, the keyword server may generate at least one keyword included in the extracted content, and the content server may re-extract a content by using said at least one keyword included in the extracted content.

Also, the system may further include an advertisement server for extracting an advertisement associated with the generated keyword or extracted content, wherein the advertisement server may provide the associated advertisement in association with at least one of the keyword and the content.

Meanwhile, in accordance with still another aspect of the present invention, there is provided a method for providing contents, the method including the steps of: extracting contents relating to a broadcast program; generating keywords for the broadcast program by using broadcast program information; collecting contents relating to the generated keywords from among the extracted contents, and matching the respective keywords to the collected contents; and providing a user interface (UI) to provide the extracted contents by displaying the matched keywords on a display unit.

Also, in accordance with still another aspect of the present invention, there is provided a system for providing contents, the system including: a keyword server for generating keywords for a broadcast program by using broadcast program information; and a content server for extracting contents relating to the broadcast program, and re-extracting at least one content relating to the respective keywords from among the extracted contents by using the keywords.

In addition, in accordance with still another aspect of the present invention, there is provided a method for providing contents, the method including the steps of: extracting contents relating to a broadcast program; generating keywords for the broadcast program by using broadcast program information; providing the keywords to be selected by a user by displaying the keywords on a display unit; and collecting contents relating to the generated keywords from among the extracted contents when the provided keywords are selected by the user.

Finally, in accordance with still another aspect of the present invention, there is provided a system for providing contents, the system including: a content server for extracting contents relating to a broadcast program; and a keyword server for generating keywords for the broadcast program by using broadcast program information, and providing the keywords to be selected by a user by displaying the keywords on a display unit, wherein when the provided keywords are selected by the user, the content server collects contents relating to the generated keywords from among the extracted contents.

### BRIEF DESCRIPTION OF THE DRAWINGS

The above and other aspects, features and advantages of the present invention will be more apparent from the following detailed description taken in conjunction with the accompanying drawings, in which:

FIG. 1 is a block diagram illustrating the configuration of a content providing system according to an exemplary embodiment of the present invention;

FIG. 2 is a flowchart illustrating a method for providing contents according to an exemplary embodiment of the present invention; and

FIGS. 3A to 3G are views explaining a procedure for providing contents according to an exemplary embodiment of the present invention.

### DETAILED DESCRIPTION OF THE EXEMPLARY EMBODIMENT

Hereinafter, one exemplary embodiment of the present invention will be described with reference to the accompanying drawings.

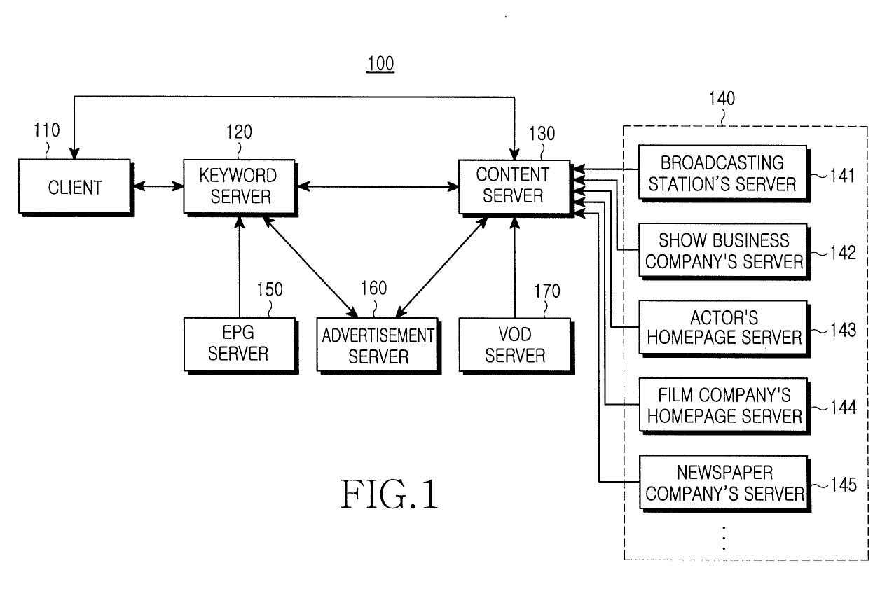

FIG. 1 is a block diagram illustrating the configuration of a content providing system 100 according to an exemplary embodiment of the present invention. The content providing system 100 according to an exemplary embodiment of the present invention includes a client 110, a keyword server 120, a content server 130, a broadcast-related server 140, an electronic program guide (EPG) server 150, an advertisement server 160, and a Video-on-Demand (VoD) server 170.

The EPG server 150 generates broadcast program information for broadcast programs. The EPG server 150 transmits the generated broadcast program information to the keyword server 120.

The broadcast program information is composed of EPG data, keywords in internet content server, keywords inputted by broadcaster and so on.

The broadcast-related server 140 collects Internet contents relating to broadcast programs. The broadcast-related server 140 includes a broadcasting station's server 141, a show business company's server 142, an actor's homepage server 143, a file company's homepage server 144 and a newspaper company's server 145, and so on.

The broadcasting station's server 141 provides the content server 130 with Internet contents, which are provided by broadcasting stations, such as ABC, NBC, and CBS, and by some cable TV stations.

The show business company's server 142 manages information about its actors, their schedules, etc., and provides the managed information to the content server 130.

The actor's homepage server 143 manages information relating to a corresponding actor, etc., and provides the managed information to the content server 130.

The film company's homepage server 144 manages information about films that have been released or are scheduled to be released by a corresponding film company, etc., and provides the managed information to the content server 130.

Meanwhile, the newspaper company's server 145 generates Internet contents provided by newspaper companies, such as the USA Today, Washington Post, and New York Times. The reason why Internet contents provided by broadcasting stations and newspaper companies are used as contents to be provided to the user, as described above, is that authenticity and reliability of contents can be maintained.

The broadcast-related server 140, including the broadcasting station's server 141 and the newspaper company's server 145, collects and transfers Internet contents relating to broadcast programs to the content server 130.

The keyword server 120 generates keywords for broadcast programs by using an electronic program guide (EPG), which is broadcast program information provided by the EPG server 150. Here, the keyword represents a word or a combination of words, which implies information relating to the respective programs, and the keyword server 120 extracts information about a title, a story line, players, background music, a location, and a genre of each program, which are provided through broadcast program information, generates keywords for broadcast programs by using the extracted information, and transmits the generated keywords to the client 110.

Meanwhile, the keyword server 120 may generate and manage keywords optionally set by the user or the operator, without using the broadcast program information provided by the EPG server 150. The operator represents a person who develops various contents, and provides or manages the developed contents. For example, the operator may be on the staff of a broadcasting station, a content provision company, etc.

For example, since a keyword, such as a “viewer forum,” is not a keyword required only for a broadcast which the user is currently viewing, the user may store the keyword “viewer forum,” and use the stored keyword.

Therefore, the keyword server 120 manages keywords for broadcast programs generated by using broadcast program information, which is provided by the EPG server 150, and keywords optionally set by the user.

The client 110 receives keywords relating to broadcast programs, which are currently being broadcasted, from the keyword server 120. Then, the client 110 selects any one among keywords, which are displayed on a display unit in connection with currently broadcasted programs, and is provided with contents relating to the selected keyword. According to an exemplary embodiment of the present invention, the client 110 may be an apparatus, including a display unit for visually providing broadcast contents to the user and a speaker for providing a sound, and may be, for example, a digital television including a set top box (STB), a terminal, etc. In addition, according to an exemplary embodiment of the present invention, the client 110 may include a graphic user interface (GUI) in order to allow the client 110 to two-way communicate with the user. Also, according to an exemplary embodiment of the present invention, the client 110 may provide the GUI to the user by displaying keywords provided by the keyword server 120 on the display unit, and may provide the user with at least one content or a list of contents relating to a keyword selected by the user through the GUI by displaying the content or the list of contents on the display unit. Also, according to an exemplary embodiment of the present invention, the client 110 may acquire contents, which are processed in a form suitable for broadcasting and are provided by the content server 130, from the keyword server 120, and may provide the acquired contents to the user through an output means, such as the display unit and the speaker.

The content server 130 extracts contents relating to the respective keywords from the broadcast-related server 140 by means of Internet keywords of the keyword server 120, and generates and manages the extracted contents.

Here, the Internet contents represent various information or contents provided through the Internet, and may include, for example, news, moving pictures, music, shopping information, advertisements, traffic information, personality information, a blog, a fan forum, and information about an original sound track (OST), and so on. Such contents may include text, an image file, a multimedia file, link information, etc.

The content server 130 provides one or more contents relating to a keyword selected by the user, wherein, when the user selects two or more contents, the content server 130 generates and provides a list of contents to the user through the client 110. The user may be provided with a desired content by selecting the desired content from a list of contents including two or more contents.

In detail, the content server 130 receives keywords from the keyword server 120, and extracts one or more contents relating to the received keywords from the broadcast-related server 140. There may exist a plurality of contents relating to one keyword. The user searches keywords displayed on the display unit of the client 110, and selects a keyword by means of a remote controller when the user finds desired information during the searching.

When the selected keyword relates to a plurality of contents, a list of contents is displayed on the display unit, and the user can acquire the desired information by selecting a desired content from among the plurality of contents by means of a remote controller.

The content server 130 processes the content extracted from the broadcast-related server 140 to be in a form suitable for broadcasting, and then provides the processed content to the keyword server 120. In this case, the content may be processed to include tag information on reservations for a personal video recorder (PVR), a Video on Demand (VoD), and an electronic program guide (EPG).

For example, while the user is viewing a soccer game in which Hines Ward is playing, the content server 130 may generate and provide a tag “Hines Ward's next game at 10 p.m. on August 8 [EPGID: 10232]” in order to notify the user of information about the next soccer game in which Park Jisung plays, and the user can make a reservation for the next soccer game by selecting the tag. Such EPG reservation information may be provided by the EPG server 150.

The VoD also may be provided in a similar manner, wherein the VoD server 170 provides information about VoD for a VoD purchase reservation.

The VoD server 170 provides information about VoD to the content server 130, and the content server 130 generates and provides a tag for a VoD purchase reservation to the keyword server 120. The advertisement server 160 provides an advertisement associated with a keyword so that the advertisement can cooperate with the keyword. In detail, the advertisement server 160 receives keywords generated by the keyword server 120, manages advertisements associated with the keywords, and enables a content according to selection of a keyword, together with an advertisement associated with the content, to be provided when the user selects the keyword.

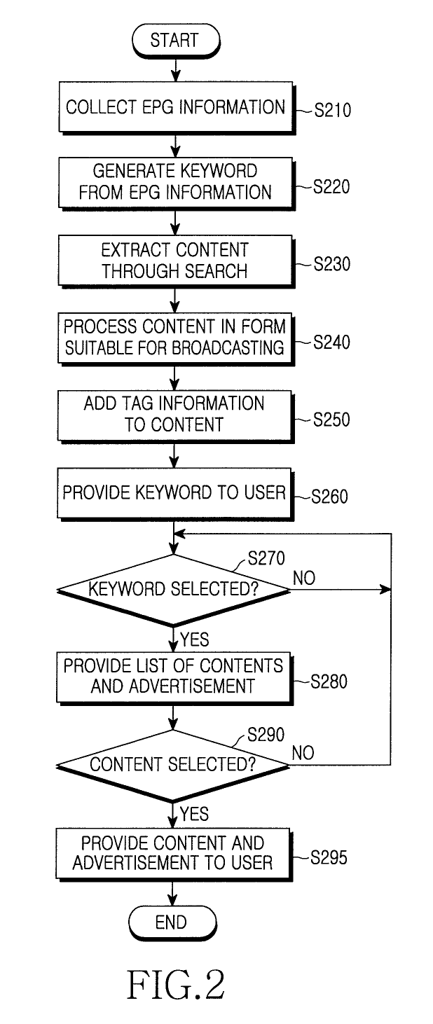

FIG. 2 is a flowchart illustrating a method for providing contents according to an exemplary embodiment of the present invention.

In step 210, the EPG server 150 collects EPG information.

The EPG server 150 transmits the collected EPG information to the keyword server 120, and the keyword server 120 generates keywords for the respective broadcast programs by using the received EPG information in step 220.

The keyword server 120 transmits information about the generated keywords to the content server 130, and the content server 130 extracts contents relating to the keywords from the broadcasting station's server 141 and the newspaper company's server 145 by searching the broadcasting station's server 141 and the newspaper company's server 145 in step 230.

The content server 130 processes the extracted contents in a form suitable for broadcasting in step 240.

Thereafter, the content server 130 adds tag information to the processed contents in step 250, wherein, when the EPG server 150 and/or the VoD server 170 is used, EPG reservation tag and/or VoD purchase reservation tag information is added.

When the processing step and the tag information adding step have been finished, the keyword server 120 provides the user with keywords relating to the respective contents in step 260.

The keywords are displayed in sequence from top to bottom on the display unit according to user preference. For example, the keywords may be displayed in sequence from top to bottom on the display unit, starting from that which corresponds best to the user's preference. That is, a keyword for which the user's preference is higher is displayed higher in the display unit than a keyword for which the user's preference is lower.

When it is assumed that the contents correspond to the show “Lost,” keywords “Mathew Fox,” “island,” and “plane” may be provided. In this case, when the user would search for characters, that is, when the user's highest preference is a character, keyword “Mathew Fox,” among the three keywords, is displayed in the upper-most position. Then, the other keywords also are displayed in regular sequence according to user preference.

Through operation of a remote controller, the user can be provided with a plurality of keywords relating to a broadcast which the user is viewing, and can select a desired keyword from among the plurality of keywords in step 270.

When the user selects a keyword in step 270, the keyword server 120 provides the user with an advertisement and a list contents, including a plurality of contents relating to the selected keyword, in step 280.

Then, the user can select a desired content from the list of contents in step 290. When the user selects a desired content in step 290, the selected content and the advertisement are provided to the user in step 295.

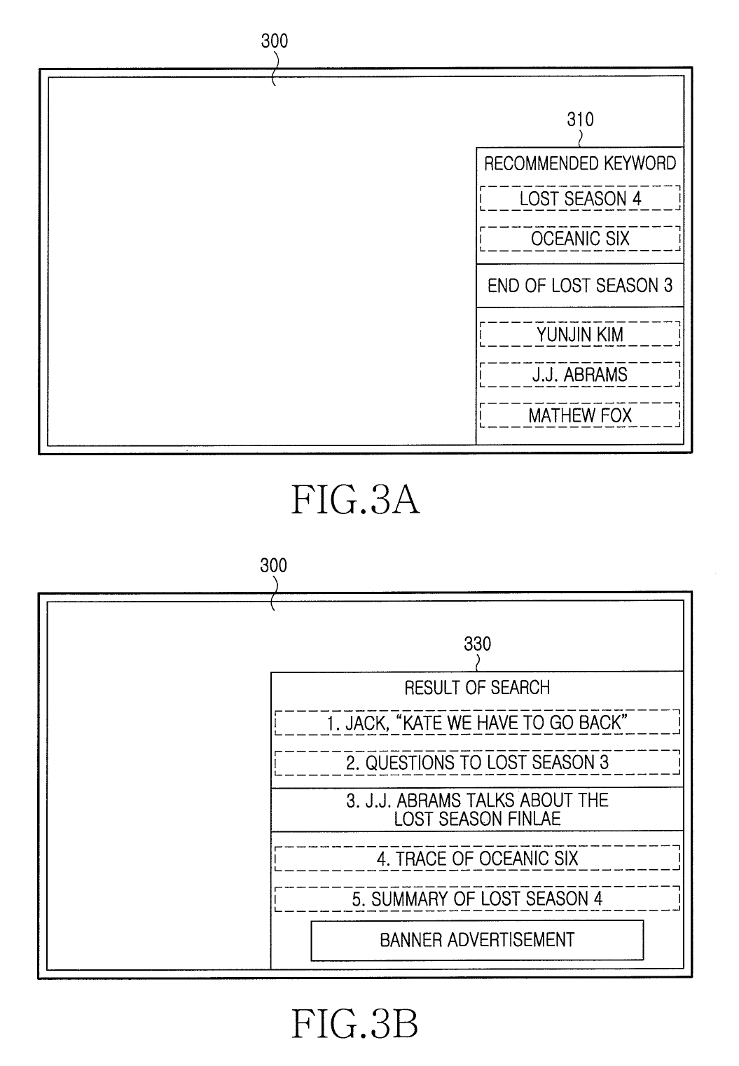

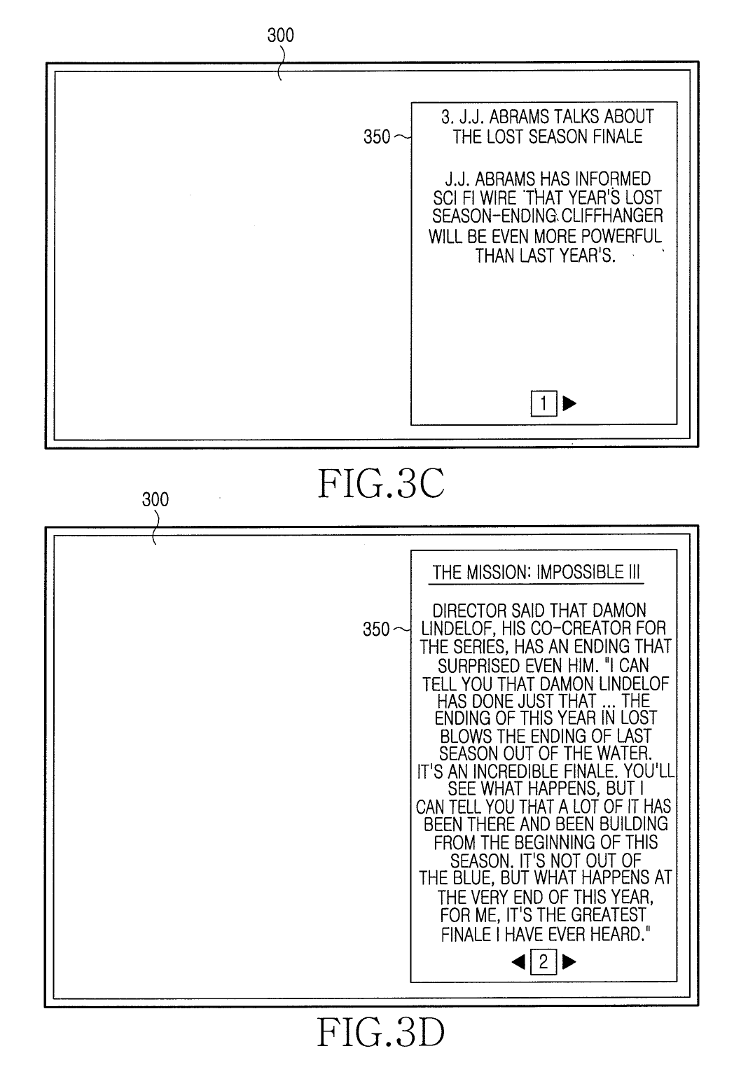

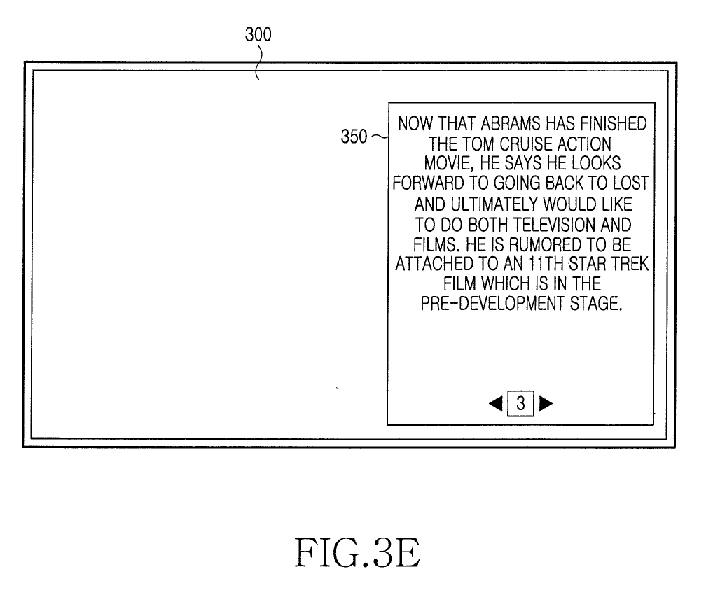

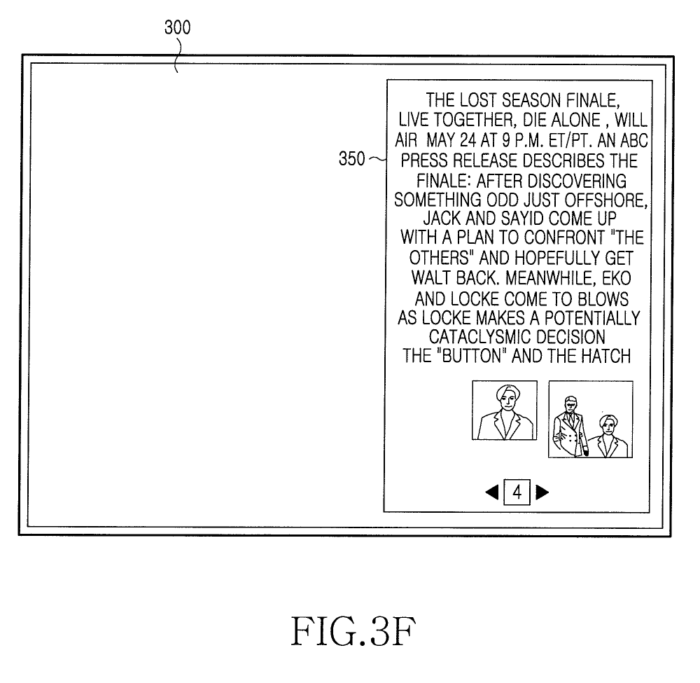

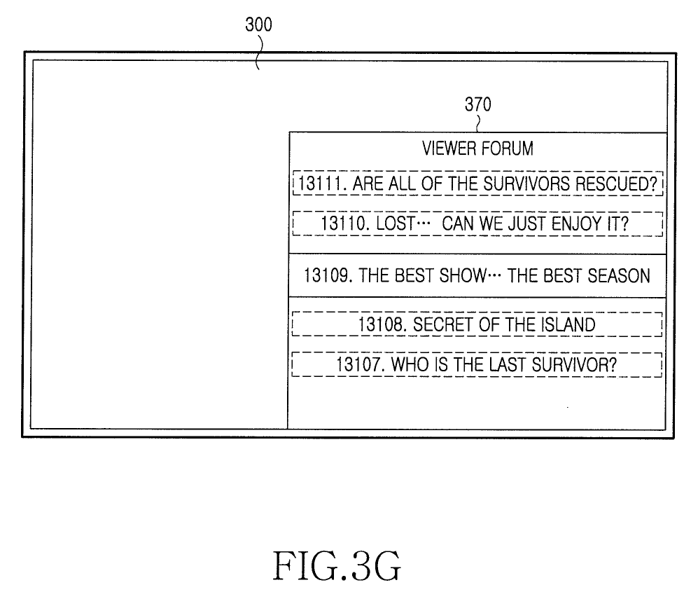

FIGS. 3A to 3D are views explaining a procedure for providing contents according to an exemplary embodiment of the present invention.

FIG. 3A is a view explaining a step of displaying keywords on a display unit, e.g. a display screen, through which the user is viewing a broadcast, so that the user can select a desired keyword. Recommended search words 310, i.e. keywords, are provided on the display unit 300. When an item to be searched for is generated while the user is viewing a broadcast, the user can be provided with a list of keywords by an input through a remote controller. Such a display unit 300 may be provided in the form of a user interface (UI), as an example.

The user may select and input keyword “End of Lost Season 3” on the display unit 300 by using only the up/down control buttons of the remote controller, without inputting characters through the remote controller.

FIG. 3B is a view explaining a step of displaying a list of contents after the user has selected a keyword. When the user selects the keyword “End of Lost Season 3” through the up/down control by the remote controller, a list of contents relating to the selected keyword is displayed on the display unit 300. In this case, a banner advertisement associated with the selected keyword is displayed together with the list of contents, thereby providing the associated advertisement to the user.

The user may select and input content “3. J.J. Abrams Talks about the Lost Season finale”” from among the list of contents, including a plurality of contents, by using only the up/down control buttons of the remote controller, without inputting characters through the remote controller.

FIG. 3C to 3F is a view explaining a step of displaying a content selected by the user on the display unit 300. When the user selects a desired content, the selected content is displayed on the display unit 300, so that the user can be provided with the desired content, without a character input operation through the remote controller.

Meanwhile, a content 350 may include text, image and streaming files, as shown in FIG. 3C to 3F, and may additionally include a multimedia file, link information, etc. That is, the user may be provided with a content relating to another keyword existing in the text by selecting said another keyword.

Meanwhile, text, image and A/V steaming files of the selected content may be displayed on a plurality of pages according to the sizes thereof. FIGS. 3C to 3F show an example where the text, image and streaming files of the selected content are displayed on four pages. In this case, according to the user input, a page shift is performed, and a selected page among the plurality of pages is displayed.

For example, in a state where a first page (e.g. the image as shown in FIG. 3C) among a plurality of pages corresponding to the selected contents has been displayed on the screen, when a state shift to the next page is requested by the user, the state shift is performed to display text, images and streaming (e.g. the image as shown in FIG. 3D) corresponding to the next page on the screen. Also, in a state where a specific page (e.g. the image as shown in FIG. 3D) has been displayed on the screen, when a state shift to the previous page is requested by the user, a state shift is performed to display the image (e.g. the image as shown in FIG. 3C) corresponding to the previous page on the screen.

FIG. 3G is a view explaining a step of displaying contents relating to a keyword optionally set by the user on the display unit 300. The user may input keyword “viewer forum” in advance, such keywords input by the user are managed, together with keywords generated based on broadcast program information, by the keyword server 120, and the user can see a viewer forum 370 by selecting the keyword “viewer forum.” In this case, the user can easily see a topic among a plurality of topics through the up/down buttons of the remote controller.

Although the embodiment of the present invention has been described about a method of generating a keyword and collecting related contents by using the generated keyword, it is only an example for the convenience of description, and the present invention may be implemented in such a manner as to collect all contents relating to broadcasts, to collect keywords by using broadcast program information, and then to match the collected keywords to the collected contents.

Also, in this case, the present invention may be implemented in such a manner that, in a state where a task of matching the keywords to the contents in advance is not performed, the user is provided with the keywords through the display unit 300, the content server 130 manages the contents, contents relating to a keyword are searched for when the user selects the keyword though the display unit 300, and the content server 130 provides the user with searched contents according to a result of the searching.

In addition, although the embodiment of the present invention has been described about a method in which the user searches for a keyword or content while the user is viewing a broadcast, it is only an example for the convenience of description, and the present invention may be implemented to enable the user to search for a keyword or content, even when the user does not view a broadcast.

Also, although the embodiment of the present invention has been described about a method in which the user searches for a keyword or content relating to a broadcast while the user is viewing the broadcast, it is only an example for the convenience of description, as well, and the present invention may be implemented to enable the user to search for keywords or contents relating to broadcasts which were already broadcasted or which are to be broadcasted in the future.

As described above, according to the present invention, the user can be provided with desired contents through selection of a keyword, even without inputting characters. Accordingly, the inconvenience and troublesomeness of character input are eliminated, and it is possible to satisfy the users' desires for acquisition of knowledge and information by actively providing various information to the users.

While the invention has been shown and described with reference to a certain exemplary embodiment thereof, the invention is not limited to the exemplary embodiment, those skilled in the art may make various changes in form and details without departing from the scope of the invention which are defined by the appended claims, and it should be understood that the spirit and scope of the invention are to cover such various changes in form and details.

What is claimed is:

1. A method for providing contents, the method comprising the steps of:
generating keywords for broadcast programs by using broadcast program information;
extracting at least one content relating to each keyword by using the keywords; and
providing a user interface (UI) to provide the at least one extracted content by displaying the keywords on a display unit.

2. The method as claimed in claim 1, wherein the extracted content corresponds to broadcast related internet contents, which comprises at least one among news, a moving picture, music, shopping information, an advertisement, traffic, personality information, a blog, a fan forum, and an original sound track (OST).

3. The method as claimed in claim 1, wherein the extracted content comprises a content provided by a broadcast-related server, and the broadcast-related server comprises at least one of a broadcasting station's server, a newspaper company's server, a show business company's server, an actor's homepage server and a film company's homepage server.

4. The method as claimed in claim 1, wherein, in the keyword generation step, the keywords are generated by using at least one among a title, a story line, players, background music, a location, and a genre of a program, which are provided through the broadcast program information.

5. The method as claimed in claim 1, wherein, in the UI provision step, the keywords for a program currently being broadcasted are displayed on the display unit.

6. The method as claimed in claim 5, wherein the keywords are displayed in sequence from top to bottom on the display unit according to user's preferences for the keywords.

7. The method as claimed in claim 1, wherein, in the UI provision step, when one among the keywords displayed on the display unit is selected, at least one content relating to the selected keyword is displayed on the display unit.

8. The method as claimed in claim 7, wherein, in the UI provision step, when there are two or more contents relating to the selected keyword, a list of contents is displayed on the display unit so that one of the contents is selected.

9. The method as claimed in claim 1, wherein, in the UI provision step, the content is processed in a form suitable for broadcasting, and is then provided.

10. The method as claimed in claim 1, wherein, in the UI provision step, the content is processed to include tag information, and is then provided.

11. The method as claimed in claim 10, wherein the tag information comprises at least one among personal video recorder (PVR) information, Video-on-Demand (VoD) information, and electronic program guide (EPG) reservation information.

12. The method as claimed in claim 1, further comprising a step of re-generating keywords based on information about the extracted content, and adding the re-generated keyword to the keywords generated by using the broadcast program information.

13. The method as claimed in claim 1, further comprising a step of adding keywords generated by a user's input to the keywords for the broadcast program, which are generated by using the broadcast program information,
wherein, in the content extraction step, the keywords generated by using the broadcast program information and the keyword generated by the user's input are used to extract the content.

14. The method as claimed in claim 1, further comprising a step of adding keywords generated by operator's input to the keywords for the broadcast program, which are generated by using the broadcast program information,
wherein, in the content extraction step, the keywords generated by using the broadcast program information and the keyword generated by the operator's input.

15. The method as claimed in claim 1, further comprising a step of re-extracting a content based on at least one keyword included in the provided content, and providing a link for the keyword in order to provide the re-extracted content to a user.

16. The method as claimed in claim 1, further comprising a step of extracting an advertisement associated with the generated keyword or extracted content,
wherein, in the UI provision step, when the keyword is displayed, or when the content is provided, the associated advertisement is provided together with the keyword or the content.

17. A system for providing contents, the system comprising:
an electronic program guide (EPG) server for providing broadcast program information;
a keyword server for generating keywords for a broadcast program by using the provided broadcast program information; and
a content server for extracting at least one content relating to each keyword by using the keywords.

18. The system as claimed in claim 17, wherein the content server extracts broadcast related internet contents, which comprises at least one among news, a moving picture, music, shopping information, an advertisement, traffic, personality information, a blog, a fan forum, and an original sound track (OST).

19. The system as claimed in claim 17, wherein the content server extracts a content provided by a broadcast-related server, and the broadcast-related server comprises at least one of a broadcasting station's server, a newspaper company's server, a show business company's server, an actor's homepage server and a film company's homepage server.

20. The system as claimed in claim 17, wherein the keyword server generates the keywords by using at least one among a title, a story line, players, background music, a location, and a genre of a program, which are provided by the EPG server.

21. The system as claimed in claim 17, wherein the keyword server provides a user with the keywords for a program currently being broadcasted.

22. The system as claimed in claim 17, wherein the keyword server provides a user with the keywords, and when one among the keywords is selected, the keyword server provides the user with at least one content relating to the selected keyword.

23. The system as claimed in claim 22, wherein when there are two or more contents relating to the selected keyword, the content server generates a list of contents.

24. The system as claimed in claim 17, wherein the content server processes the content in a form suitable for broadcasting, and provides the processed content to the keyword server.

25. The system as claimed in claim 17, wherein the content server processes the content to include tag information, and provides the processed content to the keyword server.

26. The system as claimed in claim 25, wherein the tag information comprises at least one among personal video recorder (PVR) information, Video-on-Demand (VoD) information, and electronic program guide (EPG) reservation information.

27. The system as claimed in claim 17, wherein the keyword server re-generates keywords based on information about the content extracted by the content server, and adds the re-generated keyword to the keywords generated by using the broadcast program information.

28. The system as claimed in claim 17, wherein the keyword server adds keywords generated by a user's input to the keywords for the broadcast program, which are generated by using the broadcast program information, and the content server extracts a content by means of the keywords generated by using the broadcast program information and the keyword generated by the user's input.

29. The system as claimed in claim 17, wherein the keyword server may add keywords generated by operator's input to the keywords for the broadcast program, which are generated by using the broadcast program information, and the content server may extract a content by means of the keywords generated by using the broadcast program information and the keyword generated by the operator's input.

30. The system as claimed in claim 17, wherein the keyword server generates at least one keyword included in the extracted content, and the content server re-extracts a content by using said at least one keyword included in the extracted content.

31. The system as claimed in claim 17, further comprising an advertisement server for extracting an advertisement associated with the generated keyword or extracted content, wherein the advertisement server provides the associated advertisement in association with at least one of the keyword and the content.

32. A method for providing contents, the method comprising the steps of:
extracting contents relating to a broadcast program;
generating keywords for the broadcast program by using broadcast program information;
collecting contents relating to the generated keywords from among the extracted contents, and matching the respective keywords to the collected contents; and
providing a user interface (UI) to provide the extracted contents by displaying the matched keywords on a display unit.

33. A system for providing contents, the system comprising:
a keyword server for generating keywords for a broadcast program by using broadcast program information; and
a content server for extracting contents relating to the broadcast program, and re-extracting at least one content relating to the respective keywords from among the extracted contents by using the keywords.

34. A method for providing contents, the method comprising the steps of:
extracting contents relating to a broadcast program;
generating keywords for the broadcast program by using broadcast program information;
providing the keywords to be selected by a user by displaying the keywords on a display unit; and
collecting contents relating to the generated keywords from among the extracted contents when the provided keywords are selected by the user.

35. A system for providing contents, the system comprising:
a content server for extracting contents relating to a broadcast program; and
a keyword server for generating keywords for the broadcast program by using broadcast program information, and providing the keywords to be selected by a user by displaying the keywords on a display unit, wherein when the provided keywords are selected by the user, the content server collects contents relating to the generated keywords from among the extracted contents.
